(19) United States
(12) Patent Application Publication
(10) Pub. No.: US 2006/0149464 A1
(43) Pub. Date: Jul. 6, 2006

(54) Method and system for determining the shortest elapsed time route

(76) Inventor: Huan-Wen Chien, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/149,322

(22) Filed: Jun. 10, 2005

(30) Foreign Application Priority Data
Dec. 31, 2004 (TW) 093141923

(51) Int. Cl. G01C 21/34

(52) U.S. Cl. 701/209; 701/202; 340/995.19

(57) ABSTRACT

A method and system that can determine the shortest elapsed time route in multiple routes and provide such information to users. The method comprises the steps of: a) acquiring average driving time of each of the plural route segments; b) accumulating the average driving time of each of the plural route segments in each of the plural routes; and c) selecting a route having the lowest accumulated average driving time. The system comprises plural wireless stations, a computer device, and an optimum route planning system. The plural wireless stations are installed at each first end and second end of each of the plural route segments for receiving identification information transmitted from a wireless communication device in automobiles traveling in each of the plural route segments. The computer device is communicated with the wireless stations for recording information of the time that each of the automobiles arrives in each of the first end and second end of each of the plural route segments. The optimum route planning system acquires information from the computer device and determines the shortest elapsed time route and notifies the user the shortest elapsed time route.

### TECHNICAL FIELD

This invention relates generally to a route planning method and system, in particular, a method and system for determining the shortest elapsed time route.

### BACKGROUND OF THE INVENTION

GPS (Global Positioning System) has been used to indicate location of the automobile. The conventional arts such as satellite navigation system and PaPaGO!® electronic maps series can plan a shortest route according to a user's departing point and destination. However, the shortest route doesn't guarantee the shortest elapsed time route because the shortest route only means the route that has the shortest distance in plural routes between two points. However, the driver may spend much time in the shortest route than in another route. Traffic conditions are also crucial in determining the elapsed time of driving an automobile in a route.

U.S. Pat. No. 6,611,687 discloses a system that can transmit information of a designated region to a car having a wireless receiver when the car enters the designated region. However, the system only transmits information of the designated region, such as a station of a town/city, not information of the whole route. In addition, U.S. Pat. No. 6,804,524 discloses a system that can acquire current traffic status by setting plural wireless stations to receive and gather individual automobile traffic information. However, the system fails to provide a route that costs the shortest time and to estimate driving time in the shortest elapsed time route to automobile drivers. Therefore, a system or a method that can determine the shortest elapsed time route and provide such information to users is needed.

### SUMMARY OF INVENTION

It is therefore an objective of the present invention to provide a method and system that can determine the shortest elapsed time route in multiple routes and provide such information to users.

The present invention, briefly summarized, in one embodiment discloses a method for determining the shortest elapsed time route among plural routes connecting a first location and a second location for an automobile. Each of the plural routes comprises plural route segments. The method comprises the steps of: a) acquiring average driving time of each of the plural route segments; b) accumulating the average driving time of each of the plural route segments in each of the plural routes; and c) selecting a route having the lowest accumulated average driving time. In another embodiment of the instant invention, discloses a system for determining the shortest elapsed time route among plural routes connecting a first location and a second location for an automobile. Each of the plural routes comprises plural route segments. The system comprises plural wireless stations, a computer device, and an optimum route planning system. The plural wireless stations, is installed at each of first end and second end of each of the plural route segments for receiving identification information transmitted from wireless communication devices in automobiles traveling in each of the plural route segments. The computer device is communicated with the wireless stations for recording information of the time that each of the automobiles arrives in each of the first end and second end of each of the plural route segments. The optimum route planning system acquires information from the computer device and determines the shortest elapsed time route among the plural routes according to the information and datum inputted by a user of the automobile and notifies the user the shortest elapsed time route.

### BRIEF DESCRIPTION OF DRAWINGS

The invention will be more clearly understood after referring to the following detailed description read in conjunction with the drawings wherein:

FIG. 1 is a perspective view of the instant invention;

FIG. 2 is another perspective view of the instant invention; and

FIG. 3 is a flow chart of the instant invention.

### DETAILED DESCRIPTION OF PREFERRED EMBODIMENTS

The main concept of the present invention is to detect instantaneous or estimated traffic for each route segment and to estimate a driving time, so as to provide an optimum driving route composed of plural route segments, namely to provide the shortest driving time route. Methods for detecting traffic are various, such as setting up detectors or monitors for each route segments, in order to confirm the traffic of the route segment or to directly detect a driving time for driving throughout the route segment. To the route segments with the detectors or the monitors, the driving time can be estimated instantaneously and accurately. To the route segments without the detectors or the monitors, the driving time can be estimated by reviewing history data of driving time of the route segments.

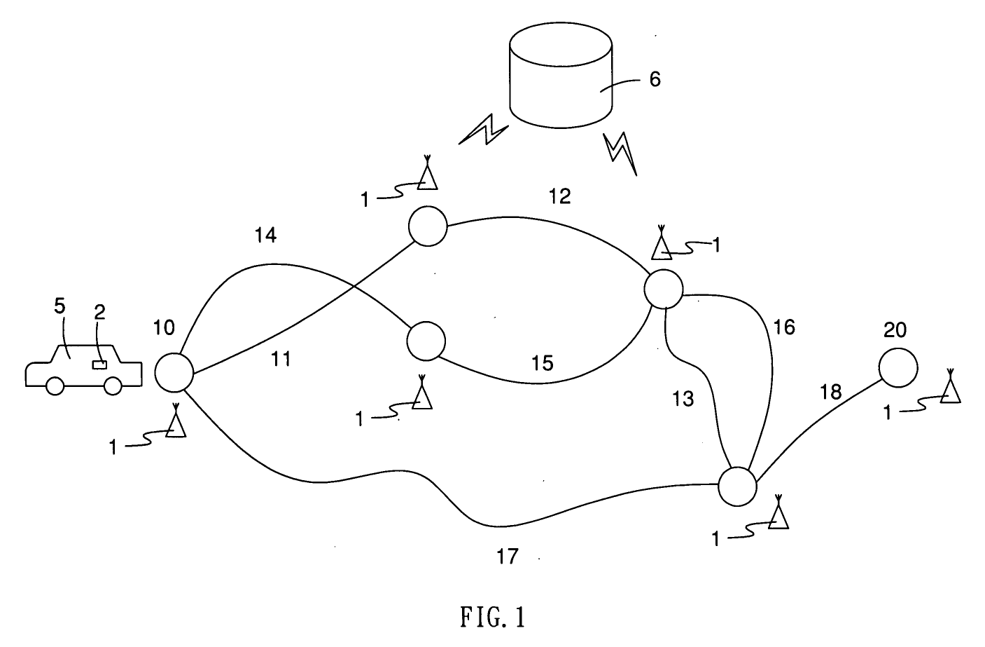

FIG. 1 shows a preferred embodiment of the present invention, which applies the detectors, namely wireless stations to determine the shortest elapses time route. With reference to FIG. 1, there are plural routes that connect a first location 10 and a second location 20. Each route contains plural route segments. For example route segments 11, 12, 16 and 18 constitute route one. Route segments 14, 15, 13, and 18 constitute route two. Route segments 14, 15, 16, and 18 constitute route three. Routes 17 and 18 constitute route four. The instant invention provides a system and a method that can determine the shortest elapsed time route among the four routes for a car 5 to be driven from location one 10 to location two 20. Plural wireless stations 1 are installed at each first end and second end of each of the plural route segments for receiving identification information transmitted from a wireless communication device 2 in an automobile 5 traveling in each of the plural route segments. A computer device 6 is communicated with the wireless stations 1 for recording information of the time that the automobile 5 arrives in each of the first end and second end of each of the plural route segments. The computer device 6 can also communicate with the wireless stations 1 through cables. The computer device 6 has a database and the computer device 6 can be installed in either of the wireless stations 1 or installed in an independent location. The wireless communication device 2 in the automobile 5 has the unique identification information. The identification information is transmitted together with signals transmitted by the wireless communication device 2 and will be received by each of the wireless stations 1 when the automobile 5 drives by the wireless stations 1.

There are many kinds of devices that have unique identification information such as GPS devices, cell phones, PDAs (personal digital assistants), bluetooth communication devices and RFID tags. These devices are commonly used in cars and are suitable to be used as the wireless communication device 2. For example, a GSM cell phone has a unique IMEI (International Mobile Equipment Identity) code and a unique SIM card. A CDMA cell phone has a unique ENS code. Therefore, if the wireless stations 1 are cell phone base stations established by telecommunication service providers, the wireless stations 1 can receive the SIM card number, IMEI code, or ESN code. In another example, an RFID tag is installed to a license plate of a car and the wireless stations 1 are RF readers installed along the roads to read the ID code of the RFID tag.

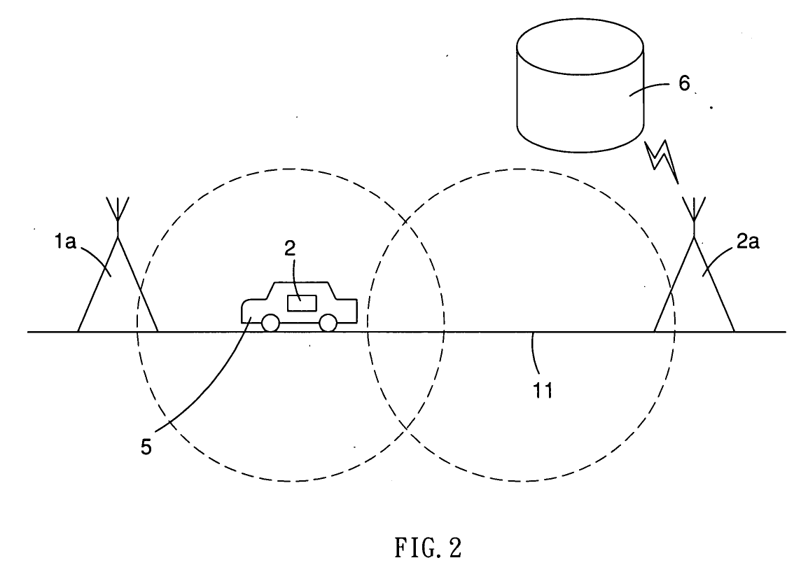

With reference to FIG. 2, the wireless communication device 2 is installed in the automobile 5. The automobile 5 drives along the route segment 11 connecting the first end and second end. The first wireless station 1 a locates at the first end and the second wireless station 2a locates at the second end.

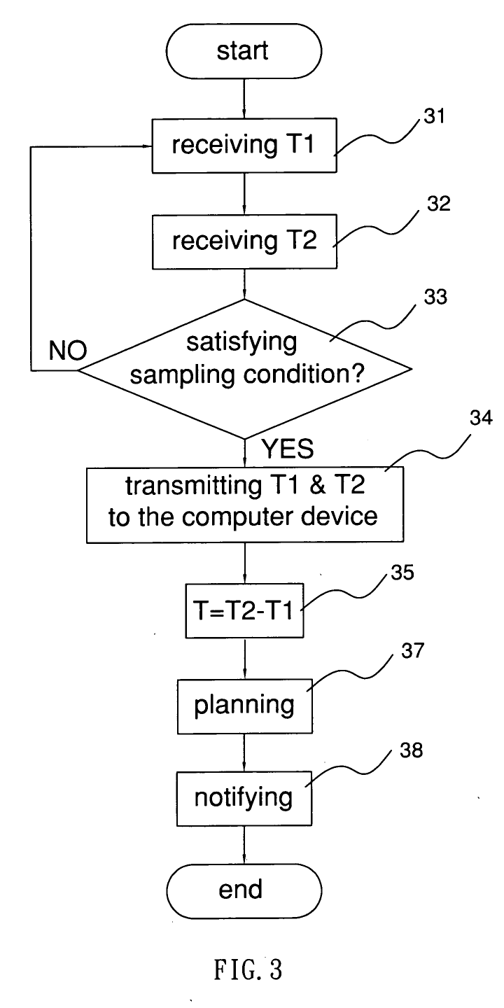

With reference to FIG. 3, a diagram discloses a method of the instant invention, wherein step 31 represents that the first wireless station 1a records a first time T1 when the first wireless station 1a receives the identification information from the automobile 5 and step 32 represents that the second wireless station 2a records a second time T2 when the second wireless station 2a receives the identification information from the automobile 5. The timing of receiving the identification information from the automobile 5 can be defined as the wireless communication device 2 in the automobile 5 is within the scope of the first wireless station 1a and the second wireless station 2a respectively or can be defined as the time that the signals detected by the first and second wireless stations 1a, 2a are strongest.

In practice, it could be more than one car driving on the route segment 11. Therefore, steps 31 and 32 will be practiced repeatedly at each of the cars carried the wireless communication device 2 driving on the route segment 11 until a sampling condition is satisfied defined as step 33. The sampling condition can be a sampling time such as 20 minutes or an hour. Alternatively, the sampling condition can be that a sampling number such as one hundred times or one thousand times of samplings has been taken. Step 34 represents that the first wireless station 1a and the second wireless station 2a temporarily saves the information of each of the time T1 and T2 taken from each automobile and then transmit the information to the computer device 6 until the sampling condition is satisfied. In a further practice, there can also be no sampling condition that means the first wireless station 1a and second wireless station 2a records all the cars carrying the wireless communication device 2 driving on the route segment 11 any time and all the information of the time T1 and T2 will be transmitted to the computer device 6 simultaneously.

As explained above, the computer device 6 receives the identification information through each of the wireless stations 1 and records the first time T1 of the first end and the second time T2 of the second end to the database.

Step 35 represents that the computer device 6 calculates a difference of the first time T1 and the second time T2 of each of the identification information, and records the difference as a driving time T of an automobile driving with the identification information through the route segment 11. The average driving time of driving through the route segment 11 can be acquired by summarize each driving time T of each recorded automobiles driving through the route segment 11 and then average the summarized number. In addition, the traffic volume of the route segment 11 (i.e., number of cars traveling on the route segment 11) can be calculated according to the number of the recorded driving time T. The driving time T, average driving time, and traffic volume can be recorded to the database via the computer device 6 in advance or they can be calculated and recorded whenever they are needed.

Some of the driving time T should be screened to conclude with a reasonable average driving time. For example, a driving time T is 30 minutes for a car to drive through a specific route segment in a regular condition; however, a calculated driving time would indicate 10 seconds for the car to drive though the specific rout segment when either the first wireless station 1a or the second wireless station 2a was miscalculated. Another example is that a car stops halfway for some reasons and then continues driving though the specific rout segment, and the driving time T is 3 hours after calculation for driving through the specific route segment. From the above examples, the unreasonable driving time T should be excluded by a screening condition. The screening condition can be that the driving time T will be recorded only when the driving time T is located between a predetermined high value and a low value or the driving time T is located between a predetermined high percentage value and a low percentage value. Such as the top 3% of the calculated driving time and the bottom 3% of the calculated driving time will be excluded.

The shorter average driving time represents the faster average driving speed of the route segment and traffic condition is good. On the contrary, the long average driving time means there is traffic jam in the route segment. Therefore a route condition broadcasting system can acquire the information of the route segment from the database through Internet access and calculate the driving speed according to the formula V=D/T (V: velocity; D: distance; T: time). When a driver is going to enter the route segment and hears from the route condition broadcasting system that the average driving velocity of the route segment is only 10 kilometers per hour, the driver can decide to avoid the traffic jam beforehand.

Referring to FIG. 3, step 37 represents that an optimum route planning system, acquires information from the computer device and determines the shortest elapsed time route among the plural routes according to the information and data inputted by a user of the automobile and notifying the user the shortest elapsed time route. The data inputted by the user include a departing location, a destination, and a departing time (or a desired arriving time). The optimum route planning system decides which routes connect the departing location and the destination and which route segments constitute each of the routes. These can be achieved by conventional electronic map techniques. The optimum route planning system then acquires the average driving time of the route segments from the database and accumulates the average driving time of the route segments in each of the routes. The route having the lowest accumulated average driving time is the optimum route or the shortest elapsed time route. Step 38 refers to notifying the user which route is the shortest elapsed time route.

With reference to FIG. 1, a user requests an optimum route service at 7:00 AM and input the departing time to 8:00 AM. The system acquires the average driving time of the route segment 11 from the database corresponding to the departing time 8:00 AM. If the average driving time of the route segment 11 is 30 minutes, the estimated arriving time of the second end will be 8:30 AM and the estimated arriving time 8:30 AM will be the departing time of the route segment 12. The system acquires the average driving time of the route segment 12 from the database corresponding to the departing time 8:30 AM. Similarly if the average driving time of the route segment 12 is 20 minutes, the estimated arriving time of the second end will be 8:50 AM and the estimated arriving time 8:50 AM will be the departing time of the route segment 16. If the average driving time of the route segment 16 is 10 minutes, the estimated arriving time of the second end will be 9:00 AM and the estimated arriving time 9:00 AM will be the departing time of the route segment 18. If the average driving time of the route segment 18 is 8 minutes, the estimated arriving time of the second end will be 9:08 AM, which is also the destination of the route. The system will estimate the time to travel through the route segments 11, 12, 16 and 18 can be calculated as 30+20+10+8=68 minutes. That means the average driving time of the route one is 68 minutes. Following the same method, the estimated average driving time of the route two, three and four can be easily estimated.

Naturally, the system of the present invention also can directly apply each departing time of each first end to estimate the driving time of the route segment, so as to determine the shortest elapsed time route. Take the above description as an example, the driving time of each route segment is estimated on the basis of the departing time being set at 8:00 AM. Although the driving time of the route segment might not be accurate in this way, operation time on the driving time for the present invention can be efficiently saved accordingly. After comparison, the shortest elapsed time route can be determined. The optimum route planning system can be installed in an Internet server, or in a personal computer or a PDA, or in the wireless communication device 2 illustrated in FIG. 1 and FIG. 2.

The actual driving time of an automobile may be different from the average driving time provided by the database. That's because different drivers have different driving habits. For a particular driver, the database can record the actual driving time and modify the estimated driving time of the route segment based on a personal parameter. For example, a driver's actual driving time of the route segment is 30 minutes while the average driving time of the route segment in the database is 40 minutes. This means the driver's driving speed is faster than other average drivers, so the driver can arrive the second end of the route segment 10 minutes earlier. The 10 minutes difference will be recorded to the database as a personal parameter and for this particular driver, the estimated driving time of the route segment will be modified as 40−10=30 minutes next time.

Based on the foregoing descriptions, we can establish a transformation table recording corresponding relationships of traffic volume and average driving time in each of the plural route segments. Therefore, once the traffic volume (number of cars traveling on the route segment) of the route segment at certain time is known, corresponding average driving time of the route segment at the certain time can be obtained according to the established transformation table. In this case, the optimum route planning system acquires traffic volume of the route segment at the certain time according to the database, and then based on the transformation table obtains the estimated average driving time of the route segment. Thereafter, the system accumulates the average driving time of each of the plural route segments in each of the plural routes that connects the first end and second end and then selects a route having the lowest accumulated average driving time as the shortest elapsed time route.

Furthermore, the traffic volume of the present invention can be obtained by following descriptions. As foregoing mentioned, the present invention can apply the detectors or the monitors to confirm and to estimate the traffic of the route segment, by setting up the detectors or the monitors at each route segments. Therefore, the traffic volume of the route segment can be detected when cars are sensed by sensors of the detectors or when review the monitors. Although this will not provide the actual driving time of the route segment, the driving time of the route segment can be transformed by applying the transformation table, so as to provide the optimum route.

In addition, the estimated driving time of the present invention also can be accomplished by the following example. On Dec. 20, 2005, a user “B” is planning to go home on Jan. 1, 2006 and estimates to arrive home at noon on that date. Therefore, the user “B” inputs the departing location, the destination, and the arriving time into the system, so as to know the estimated departing time. Alternatively, if the user “B” is requested to make a detour to pick up the user's family member “A” who works in other place, so as to go home together, the system of the present invention also can transform this request into a request for two-route planning. In other words, the first route planning is to plan the route from the departing location of the “B” to the location of the “A” and the second route planning is to plan the route from the location of the “A” to the destination of the “B,” namely the home.

In the present invention, the estimated traffic volume obtained from the wireless stations 1 is described as below. The optimum route planning system is installed in the Internet server. In the case that many users request the service of providing the shortest elapsed time route, the system acquires the traffic volume M according to the database and the number of users will be estimated that N cars will enter the route segment at certain time. Theoretically, the modified traffic volume of the route segment at certain time should be the summary of the M and the N.

However, the N is an estimated number, which is not the same as the actual number of cars K that appears on the route segment at certain time. The N should be modified by an additional modification value C to obtain a better estimated value P. Therefore the accurate estimated traffic volume should be M plus P. For example, one hundred users had made request of the service and the estimated number of car that will enter the route segment is one hundred. However, actually only 40 cars entered the route segment. Under this situation, N=100, K=40 and the additional modification value C equals 40/100=0.4. Accordingly if the traffic volume M in the database was 500 cars and the estimated number of cars N that will enter the route segment is 200 cars. The better estimated value P=200 * 0.4=80. Therefore the accurate estimated traffic volume should be 500+80 (M+P)=580 (cars).

Traffic conditions vary at different time periods. During rush hours and holidays there will be more traffic volume than non-rush hours and non-holidays. Therefore, such time modification values are used to modify the estimated average traffic time in the system.

Besides, not every car carries the wireless communication device 2. The traffic volume M should be modified by an actually measured ratio value E. For example, actually there are 100 cars driving on the route segment while the wireless stations 1 can only detect 5 cars because only 5 cars carry the wireless communication devices 2. Therefore, the actually measured ratio value E will be 100/5=20. When the wireless stations 1 detect that the traffic volume M is 6 cars, the accurate estimated traffic volume will be 6 * 20=120 cars.

The average driving time of the route segment at certain time can be obtained based on the transformation table in view of the finally modified traffic volume (number of cars). When different users make the requests of the service at different time, the system may provide different routes as the shortest elapsed time route even when the current user and the former user have input the same departing location, the same destination and the same departing time (or desired arriving time) because there may be other users using the system before the current user and cause the traffic volume to be modified and results in different route as the lowest elapsed time route. The current modifications to the traffic volume may influence the former user who has acquired the shortest elapsed time route at the former time. Hence, the former users acquired the shortest elapsed time route at the former time may choose to update the shortest elapsed time route to ensure the latest shortest elapsed time route.

Numerous characteristics and advantages of the invention have been set forth in the foregoing description, together with details of the method and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

We claim:

1. A method for determining the shortest elapsed time route among plural routes connecting a first location and a second location for a user as a reference, each of said plural routes comprises plural route segments, said method comprising the steps of:
a) acquiring average driving time of each of said plural route segments;
b) accumulating said average driving time of each of said plural route segments in each of said plural routes; and
c) selecting a route having the lowest accumulated average driving time from said plural routes.

2. The method of claim 1, wherein said step a) comprises:
providing a first wireless station and a second wireless station at a first end and at a second end respectively in each of said plural route segments for receiving identification information transmitted from wireless communications device in automobiles traveling in each of said plural route segments;
recording a first time when said first wireless station receives each of said identification information;
recording a second time when said second wireless station receives each of said identification information;
calculating a difference of said first time and said second time of each of said identification information and recording said difference as a driving time;
screening said driving time in a period to that said first time thereof corresponds to select qualified driving time in each of said plural route segments; and
acquiring a departing average driving time of each of said plural route segments by averaging all qualified driving time.

3. The method of claim 2, wherein said qualified driving time is a driving time located between a low value and a high value.

4. The method of claim 2, wherein said qualified driving time is a driving time located between a low percentage value and a high percentage value.

5. The method of claim 1, wherein said average driving time of each of said plural route segments is an estimated average driving time at the first time that an automobile is at said first end and will take to drive from said first end to said second end of each of said plural route segments.

6. The method of claim 5, wherein said average driving time of each of said plural route segments is modified by a time modification value.

7. The method of claim 1, wherein said average driving time of each of said plural route segments is modified by a personal parameter.

8. A method for determining the shortest elapsed time route among plural routes connecting a first location and a second location for a user as a reference, each of said plural routes comprises plural route segments, said method comprising the steps of:
a) establishing a transformation table recording corresponding relationships of traffic volume and average driving time in each of said plural route segments;
b) acquiring a traffic volume in each of said plural route segments depending on a departing time of said user;
c) acquiring an average driving time according to said transformation table;
d) accumulating said average driving time of each of said plural route segments in each of said plural routes; and
e) selecting a route having the lowest accumulated average driving time.

9. The method of claim 8, wherein said step a) comprises:
providing a first wireless station and a second wireless station at a first end and a second end respectively in each of said plural route segments for receiving identification information transmitted from wireless communication devices in automobiles traveling in each of said plural route segments;
recording a first time when said first wireless station receives each of said identification information;
recording a second time when said second wireless station receives each of said identification information;
calculating a difference of said first time and said second time each of said identification information and recording said difference as a driving time;
screening said driving time in a period to that said first time thereof corresponds to select qualified driving in each of said plural route segments; and
calculating the number of qualified driving time to obtain traffic volume in each of said plural route segments in a period to that said first time thereof corresponds.

10. The method of claim 9, wherein said qualified driving time is a driving time located between a low value and a high value.

11. The method of claim 9, wherein said qualified driving time is a driving time located between a low percentage and a high percentage.

12. The method of claim 8, wherein said average driving time of each of said plural route segments is an estimated average driving time at the first time that an automobile is at said first end and will take to drive from said first end to said second end of each of said plural route segments.

13. The method of claim 8, wherein said traffic volume of each of said plural route segments at said departing time of said user is modified according to number of users using said method.

14. The method of claim 13, wherein said traffic volume of each of said plural route segments depending on said departing time of said user is modified according to an additional modification value.

15. The method of claim 8, wherein said step c) further comprises acquiring said average driving time at said departing time according to a personal parameter.

16. A system for determining the shortest elapsed time route among plural routes connecting a first location and a second location for a user as a reference, each of said plural routes comprises plural route segments, said system comprising:
plural wireless stations, installed at a first end and a second end of each of said plural route segments for receiving identification information transmitted from wireless communication devices in automobiles traveling in each of said plural route segments;
a computer device communicated with said wireless stations for recording information of the time that each of said automobiles arrives in each of said first end and said second end of each of said plural route segments; and
an optimum route planning system, acquiring information from said computer device and determining the shortest elapsed time route among said plural routes according to said information and data inputted by said user and notifying said user of said shortest elapsed time route.

17. The system of claim 16, wherein said computer device records and calculates driving time of each of said automobiles in each of said plural route segments according to said information.

18. The system of claim 16, wherein said data inputted by said user includes a departing location, a destination, and a departing time.

19. The system of claim 16, wherein said data inputted by said user includes a departing location, a destination, and a desired arriving time.
